(19) United States
(12) Patent Application Publication
(10) Pub. No.: US 2006/0049587 A1
(43) Pub. Date: Mar. 9, 2006

(54) Tool connector

(76) Inventor: Webster Robert Cornwell, Ronan, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/937,734

(22) Filed: Sep. 9, 2004

(51) Int. Cl. B23B 31/107

(52) U.S. Cl. 279/75

(57) ABSTRACT

A tool connector (20) includes a shaft (22) and a collar (24). The shaft has a first shaft contact surface (70) and a second shaft contact surface (74). The collar is slidably coupled to the shaft to reciprocate the tool connector between a locked position and first and second unlocked positions.

### FIELD OF THE INVENTION

This invention relates generally to tool connectors, and more specifically to double-bias accessory connectors for power tools.

### BACKGROUND OF THE INVENTION

Two-way quick release connections are known in the art. For example, see U.S. Pat. No. 6,543,959, assigned to Jore Corporation, which describes a two-way tool connector that is manipulable by using either a pulling or a pushing motion, such as by an operator's thumb. The construction of the tool connector disclosed by Jore, however, requires multiple parts. Therefore, there exists a need for a tool connector that includes less parts than the tool connectors currently available.

### SUMMARY OF THE INVENTION

A tool connector includes a shaft and a collar. In one embodiment, the shaft has first and second shaft contact surfaces in opposed disposition along a length of the shaft. The shaft can be adapted to receive an accessory. The collar is slidably coupled to the shaft to reciprocate the tool connector between a locked position and first and second unlocked positions.

In another embodiment, the tool connector includes a biasing member disposed between the first and second shaft contact surfaces and operatively contacting the collar. In yet another embodiment, the tool connector includes means for biasing disposed between the first and second shaft contact surfaces and operatively associated with the collar.

In another embodiment, the biasing member has first and second contact surfaces, and the collar has first and second contact surfaces. When the collar is in the unlocked position, the first biasing member contact surface is in contact with the first shaft contact surface and the first collar contact surface, and the second biasing member contact surface is in contact with the second shaft contact surface and the second collar contact surface. When the collar is in the first unlocked position, the first biasing member contact surface is in contact with the first collar contact surface, and the second biasing member contact surface is in contact with the second shaft contact surface. And, when the collar is in the second unlocked position, the first biasing member contact surface is in contact with the first shaft contact surface, and the second biasing member contact surface is in contact with the second collar contact surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of a tool connector constructed in accordance with one embodiment of the present invention, with an accessory connected to the tool connector;

FIG. 2 is an isometric exploded view of the tool connector of FIG. 1;

FIG. 3 is a partial cross-sectional view of the tool connector with an accessory connected to the tool connector in a locked position;

FIG. 4 is a partial cross-sectional view of the tool connector with an accessory connected to the tool connector in a first unlocked position displaced from the locked position of FIG. 3; and

FIG. 5 is a partial cross-sectional view of the tool connector with an accessory connected to the tool connector in a second unlocked position displaced from the locked position of FIG. 3.

### DETAILED DESCRIPTION OF THE PREFERRED EMBODIMENT

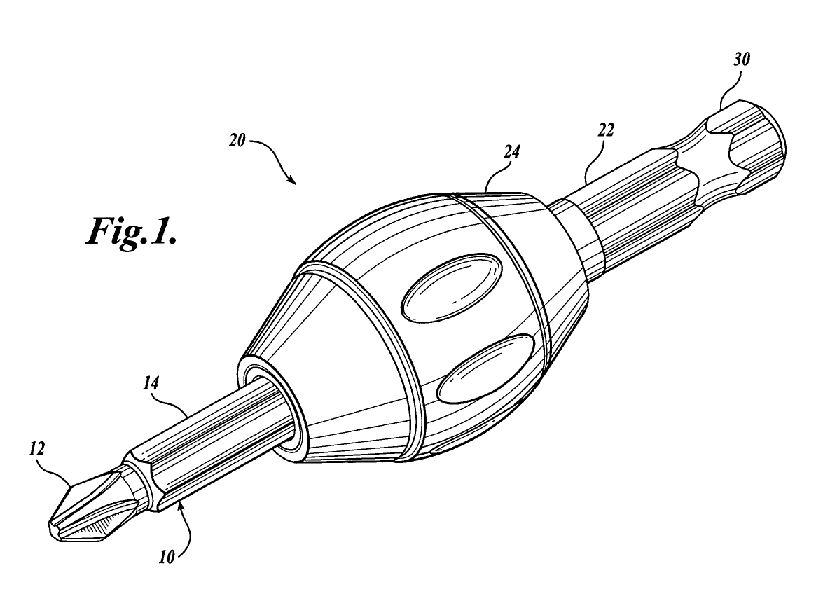

A tool connector 20 constructed in accordance with one embodiment of the present invention may be best understood by referring to FIGS. 1-3. The tool connector 20 generally includes a shaft 22 and a collar 24 slidably coupled to the shaft 22. The tool connector 20 further includes a biasing assembly 26.

At one end, the shaft 22 includes a hex shank 30. At the other end, the shaft 22 includes a longitudinally-spaced accessory attachment end 32 for receiving an accessory 10. The hex shank 30 is adapted for attachment to a well-known tool, such as a power drill.

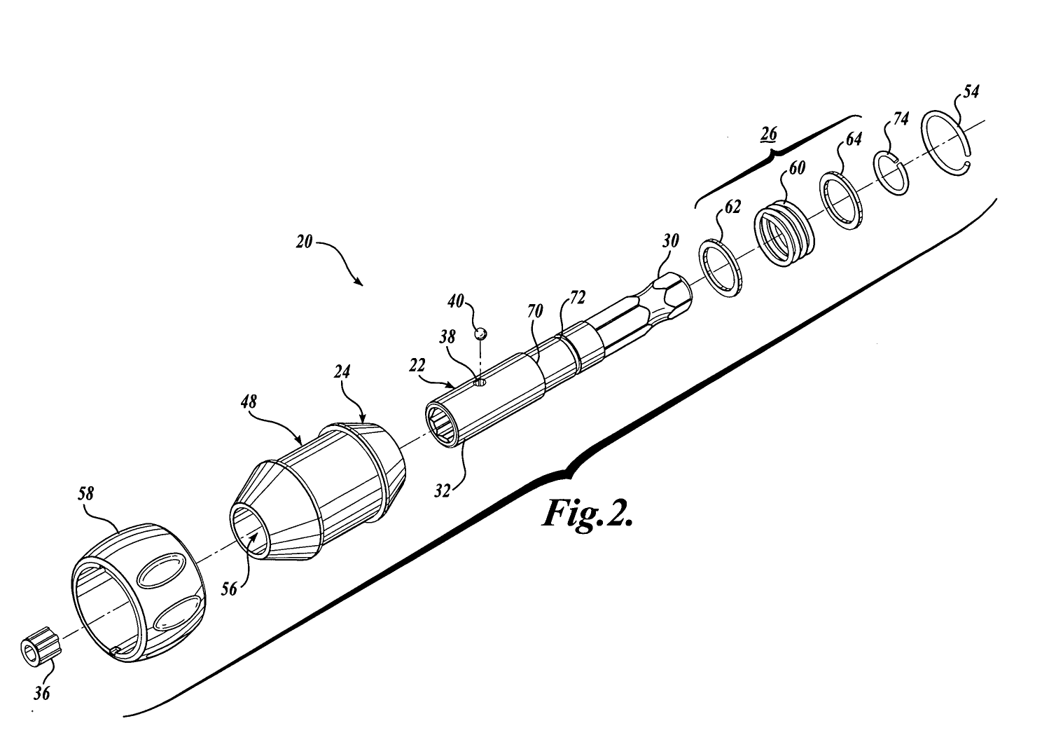

Although the shaft 22 includes a hex shank 30 in the illustrated embodiment of FIG. 2, it should be appreciated that the shaft 22 may include other shanks suitably shaped and configured to cooperate with other equipment. As a non-limiting example, the shaft 22 may be permanently attached to a handle, thereby eliminating the hex shank altogether.

The accessory 10 is illustrated in FIGS. 1 and 3-5 as a standard Phillips head screwdriver bit 12. However, it should be appreciated that other types of accessories, such as flat head screw drivers or drill bits, are also within the scope of the invention. The accessory 10 includes an attachment shank 14 and an annular ball retention groove 16.

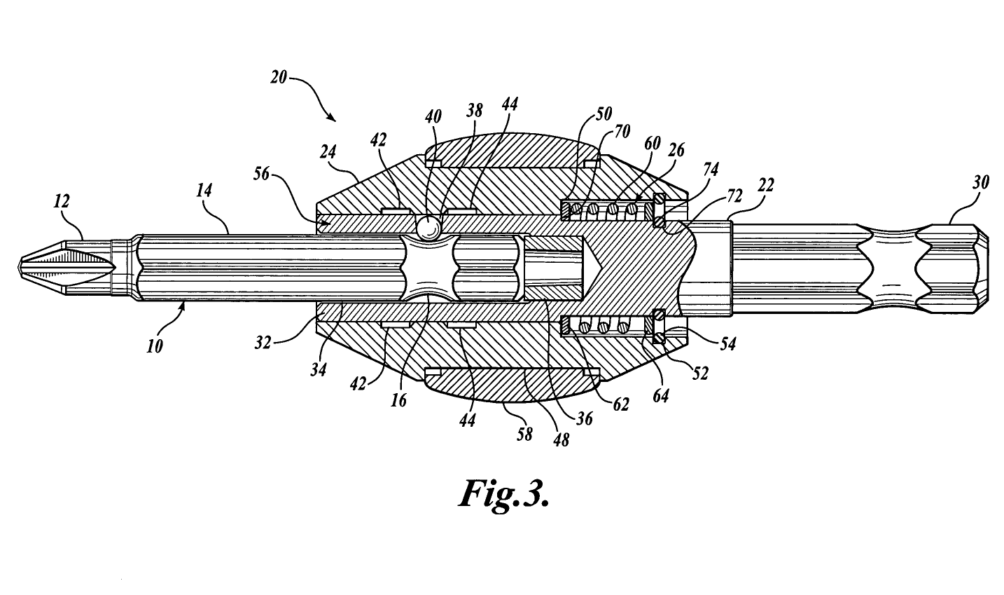

The accessory attachment end 32 of the shaft 22 includes a hexagonally-shaped bore 34 extending partially through the longitudinal direction of the shaft 22. The bore 34 is sized and configured to receive and couple to the shank 14 of the accessory 10, as is well-known in the art. Referring to FIGS. 2 and 3, the tool connector 20 further includes a well-known plug 36 received within the bore 34.

The shaft 22 will now be described in greater detail. The shaft 22 includes an annular shoulder 70 extending peripherally around the perimeter of the shaft 22 to define a shaft first contact surface. The shaft shoulder 70 is suitably positioned between the tapered hole 38 and the hex shank 30.

The shaft 22 further includes an annular shaft groove 72. The shaft groove 72 is sized and configured to receive a shaft retaining clip 74. The shaft retaining clip 74 may be a round spring, a spring clip, a snap ring, an o-ring, or any other retaining clip known to one of ordinary skill in the art. The shaft retaining clip 74 creates a protrusion on the shaft 22, and thereby defines a second shaft contact surface.

Thus, the shaft shoulder 70 and the shaft retaining clip 74 define first and second shaft contact surfaces, which are in opposed disposition along a length of the shaft 22. As such, the first and second contact surfaces are facing one another.

The shaft 22 further includes an accessory locking mechanism, which will now be described. Referring to FIG. 2, the shaft 22 includes a tapered hole 38 extending from the outer surface of the shaft 22 into the shaft bore 34. The tapered hole 38 is oriented such that it tapers from an opening located on the outer surface of the shaft 22 through to an opening in the shaft bore 34.

The tapered hole 38 is sized and configured to receive a ball bearing 40. As received in the tapered hole 38, the ball bearing 40 is positioned to selectively engage the ball retention groove 16 of the accessory 10 to releasably couple the accessory 10 to the tool connector 20. The operation of the shaft locking mechanism will be described in detail below.

As may be best seen by referring to FIGS. 2 and 3, the collar 24 will now be described in greater detail. The collar 24 is suitably a barrel-shaped member and includes a longitudinally extending channel 56. The channel 56 is sized to permit the collar 24 to be received on, or slidably couple to, the shaft 22.

In another embodiment, the collar 24 can be a two-piece collar as disclosed in U.S. Pat. No. 6,543,959, entitled “Two-Way Quick Connector,” issued to Jore, the disclosure of which is hereby expressly incorporated by reference.

As may be best seen by referring to FIG. 3, the collar 24 includes an annular shoulder 50 formed within one end of the channel 56. The shoulder 50 is positioned to engage a portion of the biasing assembly 26 and defines a first collar contact surface. This aspect will be defined in greater detail below.

Still referring to FIG. 3, the collar channel 56 includes first and second ball bearing clearance grooves 42 and 44. The first and second ball bearing clearance grooves 42 and 44 are sized and configured to selectively receive a portion of the ball bearing 40 when the connector 20 is reciprocated into one of two unlocked positions, as described in detail below. The first and second ball bearing clearance grooves 42 and 44 are spaced by a cam 46 formed in the collar channel 56.

The collar channel 56 further includes an annular collar groove 52. The collar groove 52 is sized and configured to receive a collar retaining clip 54. Similar to the shaft retaining clip 74, the collar retaining clip 54 may be a round spring, a spring clip, a snap ring, an o-ring, or any other retaining clip known to one of ordinary skill in the art. The collar retaining clip 54 creates a protrusion or a second collar contact surface along the collar channel 56.

Thus, the collar shoulder 50 and the collar retaining clip 54 define the first and second collar contact surfaces, which extend from the channel 56 of the collar 24, and like the first and second shaft contact surfaces, are in opposed disposition with one another.

The tool connector 20 further includes an optional grip sleeve 58 received in a recess 48 defined on the outer perimeter of the collar 24. The grip sleeve 58 provides for easy handling of the tool connector 20 by a user.

The biasing assembly 26 is slidably, or moveably, disposed on the shaft 22 between the inner surface of the collar 24 and the outer surface of the shaft 22. In the illustrated embodiment of FIG. 2, the biasing assembly 26 includes a spring or biasing member 60, and first and second washers 62 and 64. The first and second washers 62 and 64 are disposed at opposite ends of the spring 60. As assembled, the first and second washers 62 and 64 form first and second biasing assembly contact surfaces.

In another embodiment, the biasing assembly 26 may not include first and second washers 62 and 64. In this embodiment, the fore and aft ends of the spring 60 are the first and second contact surfaces for the biasing assembly 26. As a result, other biasing assembly configurations are also within the scope of the present invention.

Now referring back to FIG. 3, the biasing assembly 26 is disposed on the shaft 22 between the shaft shoulder 70 and the shaft retaining clip 74. In another embodiment of the present invention, the tool connector includes means for biasing. Means for biasing includes springs, belts, fluid compression systems, wave springs, or any other equivalent means for biasing known to one of ordinary skill in the art.

Operation of the tool connector 20 may be best understood by referring to FIGS. 3-5. Generally described, the tool connector is biased in a locked position, but positionable in a first unlocked position and a second unlocked position by pushing and pulling motions, for example, by the force of a user's thumb, on the collar 24.

Referring to FIG. 3, the tool connector 20 is biased in the locked position with the ball bearing 40 resting against the cam 46 between the first and second ball bearing clearance grooves 42 and 44 in the collar channel 56. The collar shoulder 50 and the shaft shoulder 70 are in alignment with one another to form a single contact surface, and the collar retaining clip 54 and the shaft retaining clip 74 are in alignment with one another to form a second single contact surface.

When the tool connector 20 is in the locked position, the collar shoulder 50 and the shaft shoulder 70 are in direct contact with the first washer (or the first contact surface) 62 of the biasing assembly 26. Additionally, the collar retaining clip 54 and the shaft retaining clip 74 are in direct contact with the second washer (or the second contact surface) 64 of the biasing assembly 26.

In the locked position, the collar cam 46 maintains the ball bearing 40 in a radially inward position, or a “locked position,” such that the ball bearing 40 sits within the ball retention groove 16 of the accessory 10 and prevents the accessory 10 from being removed from the bore 34.

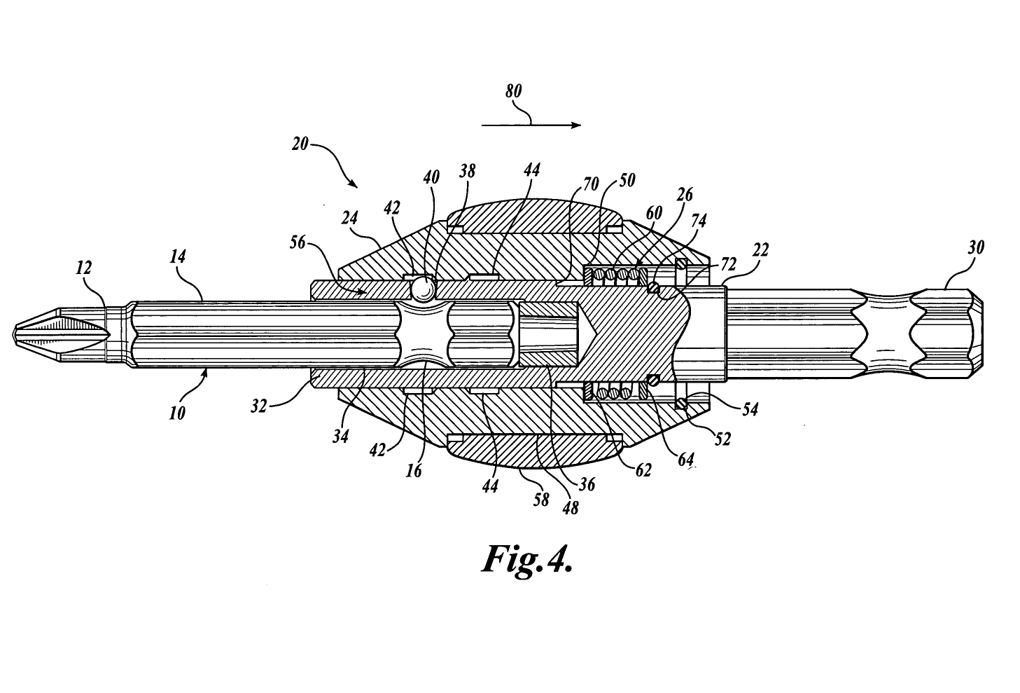

Referring to FIG. 4, the tool connector 20 is positioned in the “unlocked position,” relative to the locked position as shown in FIG. 3. Force 80 applied axially to the collar 24 causes the collar to move relative to the shaft 22. As the collar 24 moves relative to the shaft 22, the spring 60 is compressed between the collar shoulder (first collar contact surface) 50 and the shaft retaining clip (second shaft contact surface) 74.

As the tool connector 20 is forced into the first unlocked position, the first ball bearing clearance groove 42 in the collar 24 aligns with the radially tapered hole 38 in the shaft 2 and the ball bearing 40 is free to move outwardly into the first ball bearing clearance groove 42. When the ball bearing 40 moves outwardly, it moves into an “unlocked position,” such that the accessory 10 can be removed from, or inserted into, the shaft bore 34.

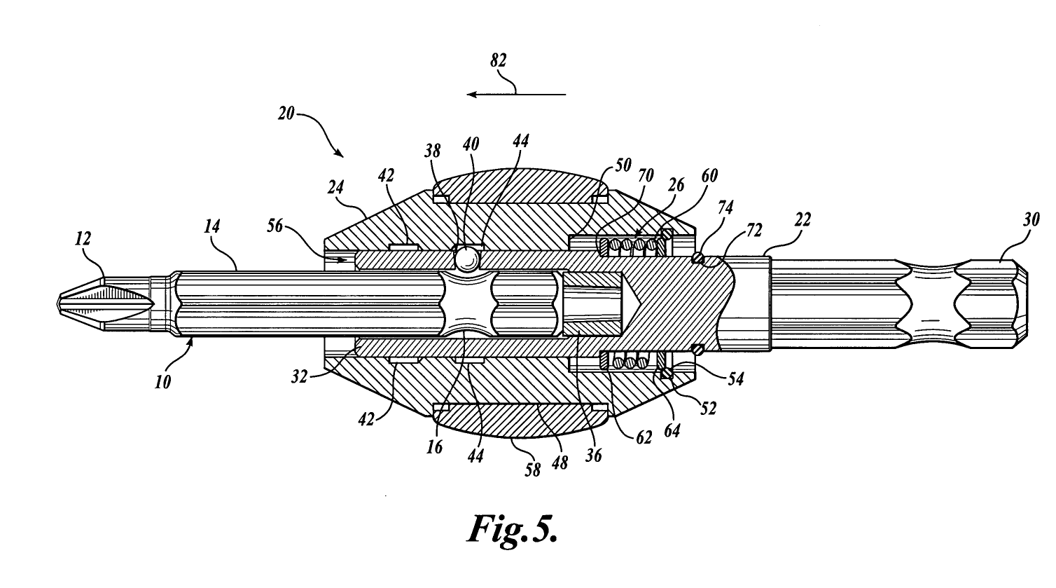

The same result can be achieved by exerting a force in the opposite direction on the collar 24. Referring to FIG. 5, the tool connector 20 is positioned in the “unlocked position” relative to the locked position as shown in FIG. 3. Force 82 applied axially to the collar 24, in the opposite direction of force 80 (FIG. 4), causes the collar to move relative to the shaft 22, but in the opposite direction of the movement illustrated in FIG. 4. As the collar 24 moves relative to the shaft 22, the spring 60 is again compressed, but this time between the external shaft shoulder 70 and the collar retaining clip 54.

As the tool connector 20 is forced into the second unlocked position, as shown in FIG. 5, the second ball bearing clearance groove 44 in the collar 24 aligns with the radially tapered hole 38 in the shaft 22 and the ball bearing 40 is free to move outwardly into the second ball bearing clearance groove 44. As described above, when the ball bearing 40 moves outwardly, it moves into an “unlocked position,” such that the accessory 10 can be removed from, or inserted into, the shaft bore 34.

The biasing assembly 26 is thus disposed on the shaft 22 for reciprocating movement and is compressible in both first and second unlocked positions (FIGS. 4 and 5). When forces 80 and 82 are removed, the tool connector 20 returns to its biased or locked position, as shown in FIG. 3.

While the preferred embodiment of the invention has been illustrated and described, it will be appreciated that various changes can be made therein without departing from the spirit and scope of the invention.

1. A tool connector, comprising:
(a) a shaft having first and second shaft contact surfaces in opposed disposition along a length of the shaft; and
(b) a collar coupled to the shaft to selectively reciprocate the tool connector between a locked position and first and second unlocked positions.

2. The tool connector of claim 1, wherein the first shaft contact surface is a shoulder and the second contact surface is a retaining clip.

3. The tool connector of claim 1, wherein the collar is normally positioned in the locked position.

4. The tool connector of claim 3, wherein the collar is positionable into the first unlocked position.

5. The tool connector of claim 4, wherein the collar is positionable into the second unlocked position.

6. The tool connector of claim 5, wherein the shaft includes an accessory locking mechanism.

7. A tool connector, comprising:
(a) a shaft adapted to receive an accessory, the shaft having first and second shaft contact surfaces;
(b) a collar disposed on the shaft; and
(c) a biasing member disposed between the first and second shaft contact surfaces and operatively contacting the collar.

8. The tool connector of claim 7, wherein the first shaft contact surface is a shoulder and the second shaft contact surface is a retaining clip.

9. The tool connector of claim 7, wherein the biasing member is a spring.

10. The tool connector of claim 7, wherein the collar includes a first collar contact surface and a second collar contact surface.

11. The tool connector of claim 10, wherein the biasing member includes a first biasing member contact surface and a second biasing member contact surface.

12. The tool connector of claim 11, wherein the collar is biased in a locked position, wherein the first biasing member contact surface contacts the first shaft contact surface and the first collar contact surface, and the second biasing member contact surface contacts the second shaft contact surface and the second collar contact surface.

13. The tool connector of claim 12, wherein the collar is positionable in a first unlocked position, wherein the first biasing member contact surface contacts the first collar contact surface, and the second biasing member contact surface contacts the second shaft contact surface.

14. The tool connector of claim 13, wherein the collar is positionable in a second unlocked position, wherein the first biasing member contact surface contacts the first shaft contact surface, and the second biasing member contact surface contacts the second collar contact surface.

15. The tool connector of claim 14, wherein the shaft includes an accessory locking mechanism.

16. A tool connector, comprising:
(a) a shaft adapted to receive an accessory, the shaft having first and second shaft contact surfaces;
(b) a collar disposed on the shaft; and
(c) means for biasing disposed between the first and second shaft contact surfaces and operatively associated with the collar.

17. A tool connector, comprising:
(a) a shaft defining a socket adapted to releasably receive an accessory, the shaft having a first shaft contact surface and a second shaft contact surface;
(b) a biasing member disposed on the shaft, wherein the biasing member is moveably disposed between the first and second shaft contact surfaces; and
(c) a collar coupled to the shaft and adapted for reciprocating movement between a locked position and first and second unlocked positions.

18. A tool connector, comprising:
(a) a shaft having an end adapted to releasably receiving an accessory, the shaft having a first contact surface and a second contact surface;
(b) a biasing member associated with the shaft, the biasing member having a first contact surface and a second contact surface;
(c) a collar having a first contact surface and a second contact surface, the collar being positionable between a locked position, a first unlocked position, and a second unlocked position relative to the shaft;
(d) wherein when the collar is in the locked position, the first biasing member contact surface is in contact with the first shaft contact surface and the first collar contact surface, and the second biasing member contact surface is in contact with the second shaft contact surface and the second collar contact surface;
(e) wherein when the collar is in the first unlocked position, the first biasing member contact surface is in contact with the first collar contact surface, and the second biasing member contact surface is in contact with the second shaft contact surface; and
(f) wherein when the collar is in the second unlocked position, the first biasing member contact surface is in contact with the first shaft contact surface, and the second biasing member contact surface is in contact with the second collar contact surface.
